(19) United States
(12) Patent Application Publication
(10) Pub. No.: US 2013/0041767 A1
(43) Pub. Date: Feb. 14, 2013

(54) Methods and Systems for Communicating Information from a Smart Point-of-Sale Terminal

(71) Applicants: Eran Hollander, Wallinford, PA (US); Andrew John Kese, Berwyn, PA (US); Carrie Jubinski, King of Prussia, PA (US); Nicole Carroll, Hinsdale, IL (US); Allison Lindemann, Philadelphia, PA (US)

(72) Inventors: Eran Hollander, Wallinford, PA (US); Andrew John Kese, Berwyn, PA (US); Carrie Jubinski, King of Prussia, PA (US); Nicole Carroll, Hinsdale, IL (US); Allison Lindemann, Philadelphia, PA (US)

(73) Assignee: Citibank, N.A., New York, NY (US)

(21) Appl. No.: 13/285,175

(22) Filed: Oct. 31, 2011

Related U.S. Application Data
(63) Continuation-in-part of application No. 13/206,598, filed on Aug. 10, 2011.

(51) Int. Cl. G06Q 20/20

(52) U.S. Cl. 705/17

(57) ABSTRACT

Methods and systems for communicating information from a specially programmed smart point-of-sale terminal involve receiving transaction information at the terminal, recognizing that the transaction relates to a redemption function, adjusting the transaction amount accordingly, and routing an approval request for the adjusted amount to a card issuer processor via a card association transaction processing network. In another aspect, information is received at the terminal which recognizes that the information relates to a third party function and routes a message to the third party processor via a merchant acquirer processor while bypassing the card association transaction processing network. Thereafter, the third party processor performs the third party function and returns a message related at least in part to the performance of the third party function to the smart point-of-sale terminal processor via the merchant acquirer processor.

### PRIORITY APPLICATION

The present invention is a continuation-in-part of co-pending U.S. patent application Ser. No. 13/206,598 filed Aug. 10, 2011, entitled “Methods and Systems of Electronic Messaging”, which is incorporated herein by this reference.

### FIELD OF THE INVENTION

The present invention relates generally to the field of electronically processing transaction information, and more particularly to methods and systems for communicating and processing transaction information from a specially programmed smart point-of-sale terminal.

### BACKGROUND OF THE INVENTION

“Daily deal” companies, such as GROUPON, feature discounted coupons usable at local or national merchants. However, the daily deal companies currently have no way of knowing what actually happens after the coupons are sold. They have no way of communicating with the merchants regarding, for example, whether it was worth while for a merchant to sign up with a particular daily deal company and/or whether the merchant should consider another program with the same daily deal company.

Further, there is considerable additional information, for example, regarding loyalty discounts, that is not currently communicated when a consumer swipes his or her loyalty card at a merchant's point-of-sale terminal. Assume, for example, that a consumer acquires and uses a loyalty card at one or more merchants. Typically, at some point, the consumer may become eligible for a reward, such as a discount on the purchase price of a product or a free product. Presently, the only way to allow the consumer to redeem many of those rewards may be to furnish the consumer a paper or electronic voucher to present to a merchant. To address these and other deficiencies of the prior art, there is a present need for a capability for communicating and processing many different types of information using a specially programmed smart point-of-sale terminal.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for processing and communicating information using a specially programmed smart point-of-sale terminal described herein. It is to be understood that the term “processor” as used herein, either standing alone or in combination, refers to a computer processor.

In an aspect, embodiments of the invention propose methods and systems for communicating information from a specially programmed smart point-of-sale terminal that may involve, for example, using a processor of a smart point-of-sale terminal for receiving transaction information consisting at least in part of a transaction amount and for recognizing that the transaction information also consists at least in part of information related to a redemption function. Using the smart point-of-sale terminal processor, the redemption function may be performed to produce an adjusted transaction amount. A message consisting at least in part of an approval request for the adjusted transaction amount may be routed to a processor of a card issuer via a card association transaction processing network. The approval request may be routed to the card issuer processor via a processor of a merchant acquirer and the card association transaction processing network. Such aspect may also involve, for example, receiving an approval message for the adjusted transaction amount by the smart point-of-sale terminal processor from the card issuer processor via the card association transaction processing network and the merchant acquirer processor.

In another aspect, embodiments of the invention propose methods and systems for communicating information from a specially programmed smart point-of-sale terminal that may involve, for example, receiving information by the smart point-of-sale terminal processor and recognizing that the information relates at least in part to a third party function other than a card association transaction processing network function. A third party function may include, without limitation, any action or purpose at least in part related to the received information. As an example, a third party function may be as simple as storing the information. As another example, the third party function may involve changing a transaction price amount included in the received information. As still another example, the third party function may involve redemption of a coupon or discount identified in the received information. The smart point-of-sale terminal processor thereafter may route a message consisting at least in part of the information related to the third party function to a processor of the third party while bypassing the card association transaction processing network. Thereafter, the third party processor may perform the third party function to which the information relates and to return a message related at least in part to the performance of the third party function to the smart point-of-sale terminal processor.

In such aspect, the information received at the smart point-of-sale terminal may include, for example, transaction information consisting at least in part of a transaction price amount but may consist entirely of information other than the transaction price amount The transaction information may be related at least in part to the third party function other than the card association transaction processing network function. Further, the transaction information received at the smart point-of-sale terminal may consist at least in part of payment device information, such as an account number that identifies a card association and a card issuer. The account number may consist at least in part of a bank identification number that identifies the card issuer. On the other hand, the payment device information may comprise in whole or in part other information that is not an account number. Additionally, the information received at the smart point-of-sale terminal may comprise transaction information consisting at least in part of payment instrument information in full or partial payment of the transaction price. Further, the information received at the smart point-of-sale terminal may comprise transaction information consisting of any other type of information related to full or partial payment of the transaction price. The information received at the terminal may consist at least in part of discount coupon information in full or partial payment of the transaction price. Thus, the information received at the smart point-of-sale terminal may comprise any type of information related at least in part, for example, to the third party function.

In this aspect, recognizing that the information relates at least in part to a third party function may involve, for example, recognizing from the payment device information that the transaction information relates at least in part to the function other than the card association transaction processing network function. In addition, recognizing from the payment device information that the transaction information relates at least in part to the function other than the card association transaction processing network function may involve, for example, recognizing from the payment device information that the transaction information relates at least in part to a redemption transaction. The message consisting at least in part of the information related to the third party function may be routed to the third party processor via a merchant acquirer processor. Further, performing the third party function may involve, for example, interrogating the transaction information to determine whether or not a request for action in the transaction information is eligible for approval and/or calculating a discounted transaction amount based on the transaction price amount reduced by a discount amount to produce a discounted transaction amount.

According to this aspect, returning the message related at least in part to performance of the third party function may involve, for example, returning the message which may consist at least in part of the discounted transaction amount to the smart point-of-sale terminal processor via a merchant acquirer processor. Returning the message may further involve routing a message consisting at least in part of an approval request for the discounted transaction amount to a card issuer processor by the merchant acquirer processor via the card association transaction processing network. In addition, routing the message to the card issuer processor may involve, for example, returning a message approving the discounted transaction amount to the merchant acquirer processor by the card issuer processor via the card association transaction processing network. Further, returning the message approving the discounted transaction amount to the merchant acquirer processor may involve, for example, forwarding the message approving the discounted transaction amount to the smart point-of-sale terminal processor by the merchant acquirer processor.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an overview example of key components and the flow of information between the key components for embodiments of the invention;

FIG. 2 is a flow chart that illustrates an example of the process of adjusting, adapting, or otherwise dealing with transaction information using the smart point-of-sale terminal for embodiments of the invention;

FIG. 3 is a schematic use case diagram that illustrates an example of the process of processing an “other” type transaction using the smart point-of-sale terminal for embodiments of the invention;

FIG. 4 is a flow chart that illustrates an example of the process of performing a function at an alternate destination processor using the smart point-of-sale terminal for embodiments of the invention; and

FIG. 5 is a schematic use case diagram that illustrates an example of the process of processing a redemption type transaction using the smart point-of-sale terminal for embodiments of the invention

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Aspects of embodiments of the invention propose, for example, a smart point-of-sale terminal deployed, for example, at a merchant's premises. The smart terminal may be provided with an ability to communicate information entered at the terminal to a processor at an alternate destination either in parallel to or before or after communicating regular point-of-sale transaction information, for example, via the regular card association transaction processing streams, such as one of the card association transaction processing networks.

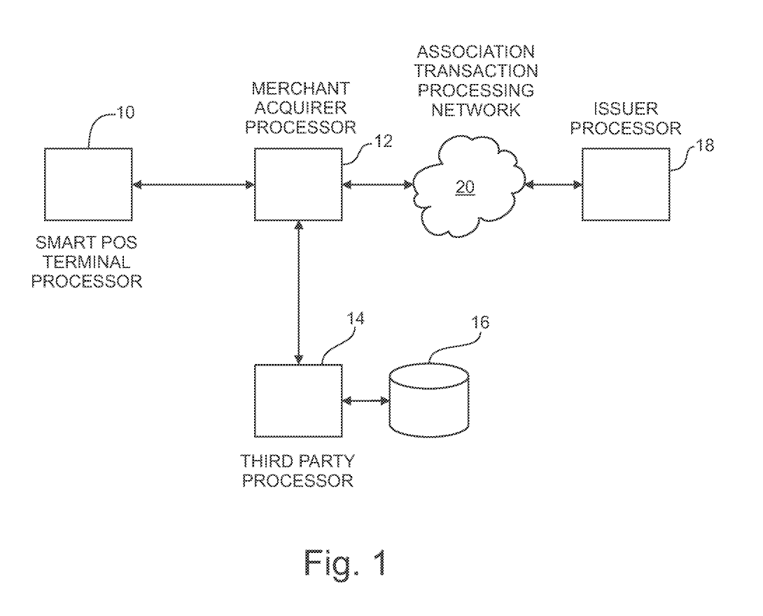

FIG. 1 is a schematic diagram that illustrates an overview example of key components and the flow of information between the key components for embodiments of the invention. Referring to FIG. 1, embodiments of the invention may employ, for example, a specially programmed smart point-of-sale terminal 10 coupled to a merchant acquirer processor 12. The merchant acquirer processer 12 may in turn communicate with a third party processor 14 that may have an associated database 16. The merchant acquirer processor 12 may also communicate with an issuer processor 18 via a card association transaction processing network 20.

For example, assume that a consumer swipes her or her loyalty card at the smart point-of-sale terminal 10 for embodiments of the invention, and the merchant recognizes that the card is a loyalty card. A standard point-of-sale terminal would simply send a request for approval of the transaction to a card issuer processor via a merchant acquirer processor and one of the card association transaction processing networks. However, upon recognizing the loyalty card, the merchant may enter information on the smart point-of-sale terminal 10 related, for example, to the loyalty card. Responsive to entry of such information, the smart terminal 10 may bypass the regular card association transaction processing stream 20 entirely and communicate the information to the third party processor 14 at the alternative destination.

The smart point-of-sale terminal 10 for embodiments of the invention may function in cooperation, for example, with any of the merchant, the merchant acquirer processor 12, the card association transaction processing network 20, the card issuer processor 18, and the alternative destination processor 14. When the information entered at the smart point-of-sale terminal 10 is received by one or more of such entities, a decision may be made and/or some action may be taken at such entity, and information may be returned to the smart terminal 10. The smart terminal 10 for embodiments of the invention may, in turn, take some action based upon the returned information.

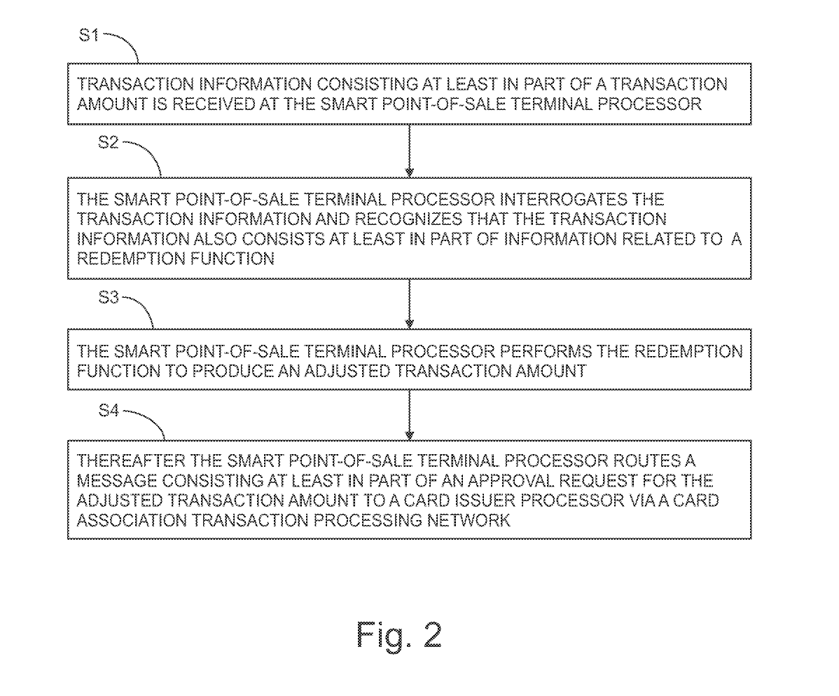

FIG. 2 is a flow chart that illustrates an example of the process of adjusting a transaction amount using the smart point-of-sale terminal for embodiments of the invention. Referring to FIG. 2, at S1, transaction information consisting at least in part of a transaction amount may be received at the smart point-of-sale terminal processor 10. At S2, the smart point-of-sale terminal processor 10 may interrogate the transaction information and recognize that the transaction information also consists at least in part of information related to a redemption function. At S3, the smart point-of-sale terminal processor 10 may perform the redemption function to produce an adjusted transaction amount. Thereafter, at S4, the smart point-of-sale terminal processor 10 may route a message consisting at least in part of an approval request for the adjusted transaction amount to the card issuer processor 18 via the merchant acquirer processor 12 and the card association transaction processing network 20.

For example, assume that the consumer wishes to purchase an item from the merchant that has a purchase price of $50. Assume also that the consumer has accrued loyalty rewards entitling the consumer to a 50% reduction in the purchase price. When that information is entered on the smart point-of-sale terminal for embodiments of the invention, a processor 10 of the smart terminal may be programmed to change the amount of the transaction approval request from $50 to $25. Thereupon, the smart terminal processor 10 may send a request for approval of the $25 transaction amount to the card issuer processor 18 via a merchant acquirer processor 12 and one of the card association transaction processing networks 20. In this way, the consumer may redeem his or her loyalty reward by receiving his or her $25 price reduction on the spot without, for example, presenting a voucher to the merchant or even requesting the redemption.

In the foregoing example, the processor 10 of the smart point-of-sale terminal for embodiments of the invention may be programmed to perform the functions described in the example automatically without manual intervention. In addition, the processor 10 of the smart terminal may be programmed to communicate any other type of information to any desired destination. Assume, for example, a loyalty program that provides a consumer a loyalty reward such as a discount or a free item for every ten uses of the loyalty card. Keeping track of the number of uses, for example, by having a merchant punch a punch card carried by the consumer may be problematic for the obvious reason that the consumer may simply forget to bring the punch card.

In the foregoing example, the processor 10 of the smart terminal for embodiments of the invention may be programmed to recognize the consumer's loyalty card each time the card is swiped at the smart terminal. The processor 10 of the smart terminal may be further programmed to store or communicate information to a particular destination processor, such as the third party processor 14 via the merchant acquirer processor 12, that the consumer's loyalty card was used at the smart terminal. When the card is swiped for the eleventh successive time at the smart terminal, the consumer may be automatically awarded the discount or may receive the free item without having to present a punch card or similar record of his or her prior purchases.

In a transaction using the smart point-of-sale terminal for embodiments of the invention, the payment device may be, for example, a physical or virtual payment device. The physical payment device may be a paper card or a plastic card, such as a magnetic stripe card or a smart card. The payment device may likewise be, for example, a contact device or a contactless proximity device, such as a mobile device with near field communication (NFC) capability. In such a transaction, the merchant may, for example, swipe the consumer's magnetic stripe card at the smart terminal or key in a consumer identifier and enter the transaction information, including a transaction amount, on an input device of the smart terminal, such as a physical or virtual keyboard or keypad. Alternatively, the consumer or the merchant may use the consumer's NFC-capable mobile device to enter information at the smart terminal.

The processor 10 of the smart terminal may be programmed, for example, to recognize a particular bank identification number (BIN) in the transaction information entered at the terminal as indicative of a type of transaction that requires communication of the transaction information to a destination other than to the card issuer 18 via one of the card association transaction processing networks 20. A BIN may be the first four to six digits of a credit card number that identify the institution that issued the card. Embedded in the credit card number is sufficient information to determine, among other things, the cardholder, with which card association network the number is associated, and the identity of the card issuer, which enables merchants to process payments through a card association transaction processing network.

The processor 10 of the smart terminal for embodiments of the invention may be programmed to interrogate the transaction information and determine whether the transaction is a “regular payment” type transaction or an “other” type transaction. For example, when no information is entered at the smart terminal that is recognized by the smart terminal processor 10 as indicative of an “other” type transaction or, for example, when the BIN entered at the smart terminal is not recognized by the smart terminal processor 10 as indicative of an “other” type transaction, the transaction may be treated by the smart terminal processor 10 as a “regular payment” type transaction.

The transaction information that is treated by the smart terminal processor 10 as a “regular payment” type transaction may be communicated together with a transaction approval request by the smart terminal processor 10, for example, via the merchant acquirer processor 12 and one of the card association transaction processing networks 20 to the card issuer processor 18 for approval of the transaction. A message approving or declining the transaction may be returned from the card issuer processor 18 via the same processing stream to the smart terminal 10 and displayed on a display screen.

On the other hand, when the BIN entered at the smart terminal 10 for embodiments of the invention is recognized by the smart terminal processor 10 as indicative of an “other” type transaction, or when the merchant enters information at the smart terminal that is recognized by the smart terminal processor 10 as indicative of an “other” type transaction, the transaction may be treated by the smart terminal processor 10 as an “other” type transaction. Entering the information indicative of an “other” type transaction by the merchant at the smart terminal may comprise, for example, selecting a physical button or key at the smart terminal or selecting an icon displayed on a display screen at the smart terminal.

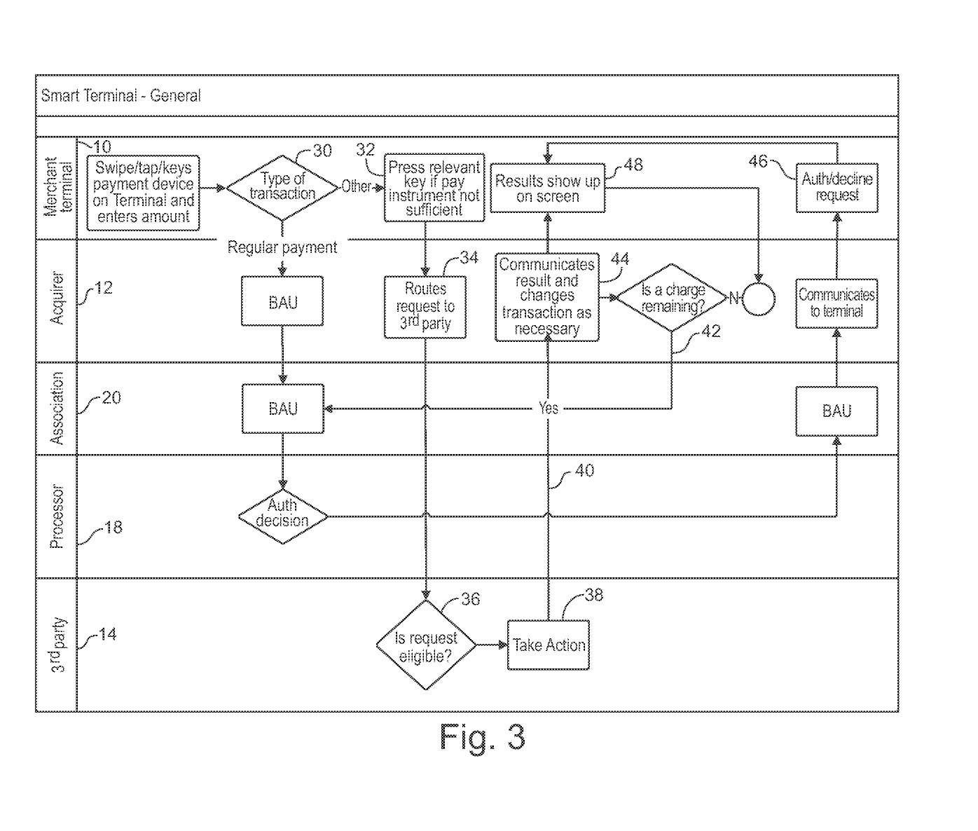

FIG. 3 is a schematic use case diagram that illustrates an example of the process of processing an “other” type transaction using the smart point-of-sale terminal for embodiments of the invention. In embodiments of the invention, an “other” type transaction may comprise, for example, a transaction in which the consumer may present a payment instrument, such as a discount coupon or voucher, in full or partial payment of the purchase price to the merchant. In other embodiments, an “other” type transaction may comprise, for example, a loyalty program transaction, which provides the consumer a loyalty reward for using a particular payment card a pre-determined number of successive times.

In either case, referring to FIG. 3, when the smart terminal processor 10 for embodiments of the invention recognizes the transaction as an “other” type transaction at 30 as shown in FIG. 3, the smart terminal processor 10 may communicate the transaction information at 32 to the processor 12 of the merchant acquirer that may own the smart point-of-sale terminal. The merchant acquirer processor 12 may, in turn, route the transaction information at 34 to the third party processor 18 instead of one of the card association transaction processing networks. The third party processor 14 may interrogate the transaction information at 36 to determine whether or not a request for an action that is included or implicit in the transaction information is eligible to be approved.

Referring further to FIG. 3, when the third party processor 14 determines that the request is eligible, the action may be taken at 38 by the third party processor 14. For example, when the “other” type transaction comprises a loyalty program transaction that provides the consumer a loyalty reward for using a particular payment card, the action may comprise, for example, determining the location of the point of sale. The third party processor 14 may determine the location of the point of sale, for example, from a merchant identifier included in the transaction information. Alternatively, the third party processor 14 may determine the location of the point of sale, for example, from geo-position information associated with a mobile device used by the consumer to perform the transaction that is included in the transaction information.

When the transaction is recognized, for example, as a loyalty program transaction that provides the consumer a loyalty reward for using a payment card a pre-determined number of successive times, the action may simply be to increment a record of the number of uses of the payment card. On the other hand, the action at 38 may involve a calculation. For example, in a transaction involving redemption of a voucher or a discount coupon, the action at 38 may include storing a record of the voucher or discount coupon redemption in the database 16 and calculating a corresponding amount to be credited to the consumer in the transaction. Other actions may include, for example, turning a device on or off or sending a communication to a mobile device.

Referring again to FIG. 3, after the action is performed at 38, the third party processor 14 may return the transaction information at 40 to the merchant acquirer processor 12. When the action at 38 involves, for example, simply incrementing a record of the number of uses of the payment card in a loyalty program, the merchant acquirer processor 12 may, if there is a charge remaining, forward the transaction information at 42, including a request for approval of the transaction amount, to the card issuer processor 18 via one of the card association transaction processing networks 20. In such a case, it is not necessary for a change to be made in the transaction amount by the merchant acquirer processor 12 before forwarding the transaction information.

However, when the transaction involves, for example, redemption of a voucher or a discount coupon in which the action at 38 includes calculating an amount to be credited to the consumer in the transaction, the merchant acquirer processor 12 may change the transaction amount at 44. Thus, the merchant acquirer 12 may reduce the transaction amount by an amount equal to the amount calculated by the third party processor 14 to be credited to the consumer in the transaction.

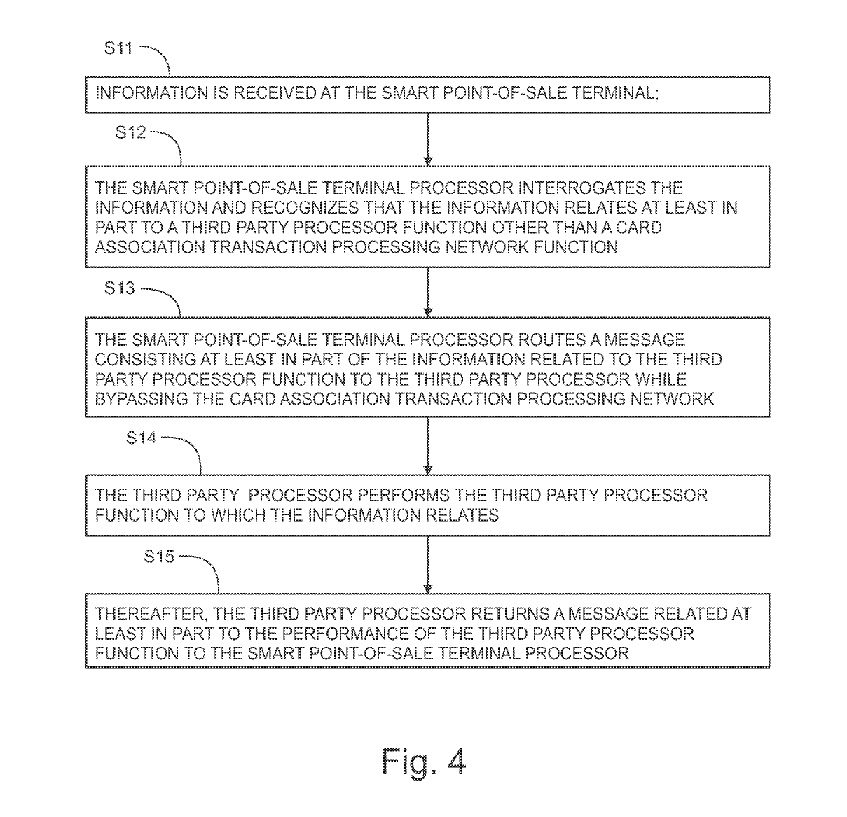

FIG. 4 is a flow chart that illustrates an example of the process of performing a function at an alternate destination processor using the smart point-of-sale terminal for embodiments of the invention. Referring to FIG. 4, at S11, information is received at the smart point-of-sale terminal, and at S12, the smart point-of-sale terminal processor 10 interrogates the information and recognizes that the information relates at least in part to a third party function other than a card association transaction processing network function. At S13, the smart point-of-sale terminal processor 10 routes a message consisting at least in part of the information related to the third party function to the third party processor via the merchant acquirer processor 12, while bypassing the card association transaction processing network 20. At S14, the third party processor 14 performs the third party function to which the information relates, and thereafter, at S15, the third party processor 14 returns a message related at least in part to the performance of the third party function to the smart point-of-sale terminal processor 10 via the merchant acquirer processor 12.

For example, referring to FIG. 3, when the function performed by the third party processor 14 involves calculation of a 50% discount on a $50 purchase price as an action at 38, the calculated amount to be credited to the consumer may be $25. The merchant acquirer processor 12 may therefore change the transaction amount at 44 from $50 to $25 before forwarding the transaction information at 42 to the card issuer processor 18 via the card association transaction processing network 20. Thereafter, a message approving or declining the transaction at 46 may be returned from the card issuer processor 18 via the same processing stream 20 to the smart terminal 10 and displayed on a display screen at 48.

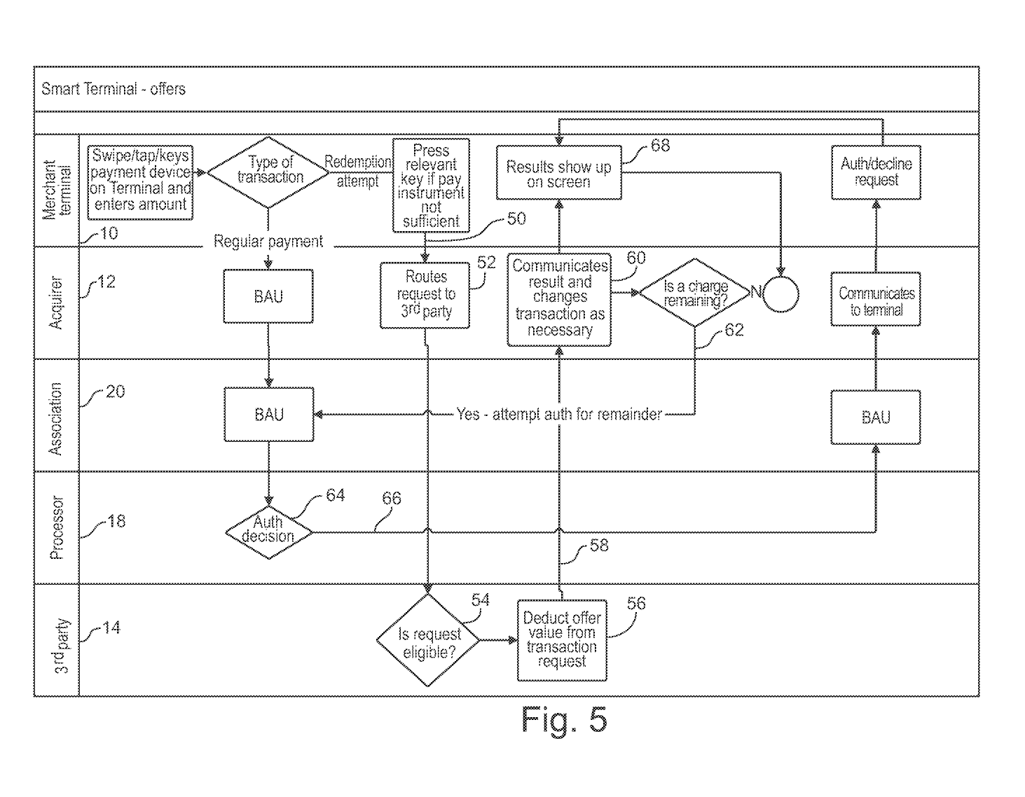

FIG. 5 is a schematic use case diagram that illustrates an example of the process of processing a redemption type transaction using the smart point-of-sale terminal for embodiments of the invention. A redemption transaction for embodiments of the invention, such as discount coupon redemption transaction, may involve the merchant selecting a physical or virtual button or screen icon at the smart terminal. Referring to FIG. 5, the transaction information, including a request to redeem a discount coupon, may be sent at 50 by the smart point-of-sale processor 10 to the merchant acquirer processor 12 and routed at 52 by the merchant acquirer processor 12 to the third party processor 14. When the third party processor 14 determines at 54 that the redemption transaction request is eligible, the third party processor 14 may calculate a redemption amount at 56 to be credited to the consumer for the discount.

Referring further to FIG. 5, the transaction information may be returned at 58 to the merchant acquirer processor 12, which may change the transaction amount by deducting the amount to be credited to the consumer for the discount at 60. If there is an overage balance of the purchase price remaining, the merchant acquirer processor 12 may then forward the transaction information, with a request for approval of the overage amount at 62, to the card issuer processor 18 via the card association transaction processing network 20. Thereafter, a message approving or declining the overage amount may be generated at 64 by the card issuer processor 18 and returned at 66 from the card issuer processor 18 via the same processing stream to the smart terminal processor 10 and displayed on a display screen at 68.

As a matter of convenience, the smart terminal for embodiments of the invention may be owned by the merchant acquirer or under an arrangement between the merchant acquirer and the third party. In the coupon redemption aspect, the third party may be the redemption provider or the loyalty provider, either or both of which may be a financial institution. In other aspects, the third party may be, for example, a government and the action may be simply to record each transaction of a consumer with a particular type of merchant, such as a gun shop.

The smart terminal for embodiments of the invention may include, for example, a card reader through which a regular payment card can be swiped and read. However, embodiments of the invention are not limited to regular payment cards. The card reader of the smart terminal may also read information, for example, from a card other than a payment card. For example, a card other than a payment card storing discount coupon or voucher information may also be read by the card reader of the smart terminal. In such case, the action by the third party processor 14 may include not only determining that the redemption request is valid and calculating an amount to be credited, but also may include, for example, determining that the consumer has registered an account, such as a credit card account to which overage amounts in redemption transactions may be charged.

In the redemption aspect, the processor 10 of the smart point-of sale-terminal for embodiments of the invention may be programmed to cause the merchant acquirer processor 12 to submit the transaction information to the third party processor 14, which may also comprise the database 16, as shown in FIG. 1, to check to see whether, for example, redemption of a discount coupon or voucher is relevant, instead of sending the transaction data from the smart terminal processor 10 directly through the card association transaction processing network 20.

The processor 10 of the smart point-of sale-terminal for embodiments of the invention may be further programmed to cause the merchant acquirer processor 12, for example, to thereafter reduce the transaction amount by the amount of the coupon redemption and to submit the overage balance into the regular card association transaction processing stream 20. Thus, with one swipe of a card at the smart terminal, the discount coupon or voucher can be redeemed and any overage amount charged to an account, such as a credit card account of the consumer. If a discount is not relevant, the transaction can simply be processed through the card association transaction processing network 20 like any other credit card transaction.

More particularly, the processor 10 of the smart point-of sale-terminal, which may be employed in an existing point-of-sale terminal, may be specially programmed to recognize a bank identification number (BIN) of a bank as a card of the particular bank and route the transaction data that was entered at the smart terminal to the third party processor 14, wherever the third party processor 14 may be located, and request an eligibility determination or other action at the third party processor 14. Such eligibility determination may include a query, such as “Is there a file in the database of a valid discount coupon that is being redeemed at the smart terminal?” For that purpose, the smart terminal may have a “Redemption” button or icon that can be selected.

An aspect of embodiments of the invention may involve registration of a card on the system regardless of the identity of the issuer. It is not necessary for a particular financial institution, such as a particular bank to be the issuer. In such aspect, when the registered card is swiped at the smart terminal for embodiments of the invention, the communication from the smart terminal processor 10 may initially bypass the card association transaction processing network 20. The smart terminal processor 10 may recognize that the card is a registered card and cause the transaction data to be communicated to the third party processor 14 that determines, for example, from the associated database 16 whether or not, for example, there is a redemption involved.

For example, a consumer may go to a discount coupon website and register his or her card, such as a credit or debit card, and buy a discount coupon. When the consumer goes to a merchant and swipes the card at the smart terminal for embodiments of the invention, a “Redemption” button or icon may be selected at the smart terminal. If there are multiple coupon promotions, for example, a “Redemption—Promotion Number One” or a “Redemption—Promotion Number Two” button or icon may be selected at the smart terminal. The swiped card may be recognized by the smart terminal processor 10 because the card was registered on the system. When the card is swiped at the smart terminal, the transaction information is sent by the smart terminal processor 10 to the merchant acquirer processor 12.

When the transaction data arrives at the merchant acquirer processor 12, the merchant acquirer processor 12 may query the transaction information and determine, for example, that the transaction information relates to a transaction with a card association card. However, the merchant acquirer processor 12 may also determine, for example, that the “Redemption—Promotion Number One” button or icon at the smart terminal was selected. Therefore, instead of forwarding the transaction data directly to the card association transaction processing network 20, the merchant acquirer processor 12 may send the transaction information to the third party processor 14 where it may be determined from the database 16 that the transaction is a redemption of a coupon in promotion number one. The third party processor 14 may also determine that there is a valid coupon on file in the database 16 for the consumer. If so, the third party processor 14 may calculate an amount by which the transaction amount should be reduced and return a message with the result to the merchant acquirer processor 12. If not, the third party processor 14 may return a “Decline” message to the merchant acquirer processor 12.

As previously noted, the smart terminal for embodiments of the invention may also be used for an overage in a redemption transaction. Assume, for example, that the value of the redemption amount is $25 but that the consumer has a $50 charge and thus needs to pay the $25 overage amount. The smart terminal processor 10 may read the consumer's credit card number and send the credit card number, together with other transaction information, to the third party processor 14 via the merchant acquirer processor 12. The third party processor 14 may verify from the database 16 that a valid coupon is on file for the consumer and send an “Approve” message for the redemption to the merchant acquirer processor 12 with a calculation of the $25 redemption amount. The merchant acquirer processor 12 may receive the approval for the $25 redemption, but since there is an overage amount of $25, the merchant acquirer processor 12 may send a credit card authorization charge request for the $25 overage amount through the card association transaction processing network 20 to the card issuer processor 18. The card issuer processor 18 may then return an approval of the $25 overage amount charge against the consumer's credit card account.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

What is claimed is:

1. A method of communicating information from a smart point-of-sale terminal, comprising:
receiving, using a smart point-of-sale terminal processor, transaction information consisting at least in part of a transaction amount;
recognizing, using the smart point-of-sale terminal processor, that the transaction information also consists at least in part of information related a redemption function;
performing, using the smart point-of-sale terminal processor, the redemption function to produce an adjusted transaction amount; and
routing, using the smart point-of-sale terminal processor, a message consisting at least in part of an approval request for the adjusted transaction amount to a card issuer processor via a card association transaction processing network.

2. The method of claim 1, wherein routing the message consisting at least in part of the approval request to the card issuer processor further comprises routing the message to the card issuer processor via a merchant acquirer processor and the card association transaction processing network.

3. The method of claim 1, further comprising, receiving an approval message for the adjusted transaction amount by the smart point-of-sale terminal processor from the card issuer processor via the card association transaction processing network and the merchant acquirer processor.

4. A method of communicating information from a smart point-of-sale terminal, comprising:
receiving, using a smart point-of-sale terminal processor, information at the smart point-of-sale terminal;
recognizing, using the smart point-of-sale terminal processor, that the information relates at least in part to a third party function other than a card association transaction processing network function;
routing, using the smart point-of-sale terminal processor, a message consisting at least in part of the information related to the third party function to the third party processor while bypassing the card association transaction processing network;
performing, using the third party processor, the third party function to which the information relates; and
returning, using the third party processor, a message related at least in part to the performance of the third party function to the smart point-of-sale terminal processor.

5. The method of claim 4, wherein receiving the information at the smart point-of-sale terminal further comprises receiving transaction information consisting at least in part of a transaction price amount and being related at least in part to the third party function other than the card association transaction processing network function.

6. The method of claim 4, wherein receiving the information at the smart point-of-sale terminal further comprises receiving transaction information consisting at least in part of payment device information.

7. The method of claim 6, wherein receiving the payment device information further comprises receiving payment device information consisting at least in part of a bank identification number.

8. The method of claim 4, wherein receiving the information at the smart point-of-sale terminal further comprises receiving transaction information consisting at least in part of payment instrument information in full or partial payment of the transaction price.

9. The method of claim 8, wherein receiving the payment instrument information further comprises receiving payment instrument information consisting at least in part of discount coupon information in full or partial payment of the transaction price.

10. The method of claim 6. wherein recognizing that the information relates at least in part to a third party function other than the card association transaction processing network function further comprises recognizing from the payment device information that the transaction information relates at least in part to the function other than the card association transaction processing network function.

11. The method of claim 10. wherein recognizing from the payment device information that the transaction information relates at least in part to the function other than the card association transaction processing network function further comprises recognizing from the payment device information that the transaction information relates at least in part to a redemption transaction.

12. The method of claim 4, wherein routing the message consisting at least in part of the information related to the third party function further comprises routing the message to the third party processor via a merchant acquirer processor.

13. The method of claim 4, wherein performing the third party function further comprises interrogating the transaction information to determine whether or not a request for action in the transaction information is eligible for approval.

14. The method of claim 5, wherein performing the third party function further comprises calculating a discounted transaction amount based on the transaction price amount reduced by a discount amount to produce a discounted transaction amount.

15. The method of claim 1, wherein returning the message related at least in part to performance of the third party function further comprises returning the message to the smart point-of-sale terminal processor via a merchant acquirer processor.

16. The method of claim 15, wherein returning the message to the smart point-of-sale terminal processor via the merchant acquirer processor further comprises returning the message consisting at least in part of a discounted transaction amount to the merchant acquirer processor.

17. The method of claim 16, wherein returning the message consisting at least in part of the discounted transaction amount to the merchant acquirer processor further comprises routing a message consisting at least in part of an approval request for the discounted transaction amount to a card issuer processor by the merchant acquirer processor via the card association transaction processing network.

18. The method of claim 17, wherein routing the message consisting at least in part of an approval request for the discounted transaction amount to the card issuer processor further comprises returning a message approving the discounted transaction amount to the merchant acquirer processor by the card issuer processor via the card association transaction processing network.

19. The method of claim 18, wherein returning a message approving the discounted transaction amount to the merchant acquirer processor further comprises forwarding the message approving the discounted transaction amount to the smart point-of-sale terminal processor by the merchant acquirer processor.

20. A system for communicating information from a smart point-of-sale terminal, comprising:
a smart point-of-sale terminal processor coupled to memory and being programmed for:
receiving information at the smart point-of-sale terminal,
recognizing that the information relates at least in part to a third party function other than a card association transaction processing network function, and
routing a message consisting at least in part of the information related to the third party function to the third party processor while bypassing the card association transaction processing network; and
the third party processor being coupled to memory and programmed for:
performing the third party function to which the information relates, and
returning a message related at least in part to the performance of the third party processor to the smart point-of-sale terminal processor.
